(19) United States
(12) Patent Application Publication
(10) Pub. No.: US 2006/0116472 A1
(43) Pub. Date: Jun. 1, 2006

(54) Compositions comprising graft polymer for extrusion processing

(76) Inventors: Harry Staratschek, Leverkusen (DE); Hertber Eichenauer, Dormagen (DE); Edgar Leitz, Dormagen (DE)

Correspondence Address: LANXESS CORPORATION, 111 RIDC PARK WEST DRIVE, PITTSBURGH, PA, 15275-1112, US

(21) Appl. No.: 11/128,711

(22) Filed: May 13, 2005

(30) Foreign Application Priority Data
May 15, 2004 (DE) 102004024270

(51) Int. Cl. C08L 51/00

(52) U.S. Cl. 525/70

(57) ABSTRACT

The present invention relates to molding compositions comprising graft polymer and featuring very good processability via extrusion without the occurrence of certain surface defects.

The present invention relates to molding compositions comprising graft polymer and featuring very good processability via extrusion without the occurrence of certain surface defects.

Plastics based on graft polymers, in particular on those of ABS type, have been used for many years as engineering plastics for production of moldings of every type (see, for example, Ullmann's Encyclopedia of Industrial Chemistry, 5^{th} Edition, Vol. A 21, pages 652-653, VCH, Weinheim, 1992), a particular use being processing via injection molding or extrusion.

Depending on the type of processing, the molding compositions used here have to comply with various requirements; by way of example, molding compositions comprising graft polymer and intended for processing by injection molding must not be the cause of any mould deposits (cf. in this connection, for example, the solution described in EP 869 147 for this problem), while molding compositions comprising graft polymer and intended for extrusion processing must not be the cause of deposits on the rolls.

One specific problem with extrusion processing is the formation of surface defects in the form of round or elongate defects with diameters of from about 0.5 to 20 mm on extruded sheets, profiles, or blow-moulded or thermoformed parts.

Surprisingly, it has now been found that the use of specific additive mixtures can give molding compositions comprising graft polymer and having very good processability via extrusion, without the occurrence of these surface defects.

The invention provides molding compositions intended for extrusion processing and comprising
A) from 5 to 95% by weight, preferably from 10 to 90% by weight, and particularly preferably from 20 to 75% by weight, of at least one thermoplastic homo-, co- or terpolymer of styrene, of α-methylstyrene, of ring-substituted styrene, of methyl methacrylate, of acrylonitrile, of methacrylonitrile, of maleic anhydride, of N-substituted maleimide, or of a mixture of these,
B) from 95 to 5% by weight (based on A+B), preferably from 90 to 10% by weight, and particularly preferably from 80 to 25% by weight, of at least one graft polymer of
   B.1) from 5 to 90 parts by weight, preferably from 20 to 80 parts by weight, and particularly preferably from 25 to 60 parts by weight, of styrene, of α-methylstyrene, of ring-substituted styrene, of methyl methacrylate, of acrylonitrile, of methacrylonitrile, of maleic anhydride, of N-substituted maleimide, or of a mixture of these, onto
   B.2) from 95 to 10 parts by weight, preferably from 80 to 20 parts by weight, and particularly preferably from 75 to 40 parts by weight, of at least one rubber with a glass transition temperature ≦10° C.,
and also
C) from 0.05 to 5 parts by weight, preferably from 0.1 to 3 parts by weight, and particularly preferably from 0.2 to 2 parts by weight (in each case per 100 parts by weight of A+B) of at least one partially oxidized polyolefin and
D) from 0.05 to 2 parts by weight, preferably from 0.08 to 1.5 parts by weight, and particularly preferably from 0.1 to 1 part by weight (in each case per 100 parts by weight of A+B) of at least one alkaline earth metal oxide selected from magnesium oxide and calcium oxide.

According to the invention, suitable thermoplastic polymers A) are those of styrene, of α-methylstyrene, of p-methylstyrene, of vinyltoluene, of halostyrene, of methyl acrylate, of methyl methacrylate, of acrylonitrile, of maleic anhydride, of N-substituted maleimide, or of a mixture of these.

The polymers A) are resin-like, thermoplastic and rubber-free. Particularly preferred polymers A are those composed of styrene, of methyl methacrylate, of styrene/acrylonitrile mixtures, of styrene/acrylonitrile/methyl methacrylate mixtures, of styrene/methyl methacrylate mixtures, of acrylonitrile/methyl methacrylate mixtures, of α-methylstyrene/acrylonitrile mixtures, of styrene/α-methylstyrene/acrylonitrile mixtures, of α-methylstyrene/methyl methacrylate/acrylonitrile mixtures, of styrene/α-methylstyrene/methyl methacrylate mixtures, of styrene/α-methylstyrene/methyl methacrylate/acrylonitrile mixtures, of styrene/maleic anhydride mixtures, of methyl methacrylate/maleic anhydride mixtures, of styrene/methyl methacrylate/maleic anhydride mixtures.

The polymers A) are known and can be prepared via free-radical polymerization, in particular via emulsion, suspension, solution, or bulk polymerization. Their average molecular weights M_{w} are preferably from 20 000 to 200 000, their intrinsic viscosities [η] preferably being from 20 to 110 ml/g (measured in dimethylformamide at 25° C.).

Graft monomers B.1) suitable for preparation of the graft polymers B) are the same as those described for the polymers A).

Particularly suitable rubbers B.2) for preparation of the graft polymers B) are polybutadiene, butadiene-styrene copolymers, butadiene-acrylonitrile copolymers, polyisoprene, or alkyl acrylate rubbers based on C₁-C₈-alkyl acrylates, in particular ethyl, butyl, ethylhexyl acrylate.

The acrylate rubbers may contain, if appropriate, up to 30% by weight (based on the weight of rubber) of copolymerized monomers such as vinyl acetate, acrylonitrile, styrene, methyl methacrylate and/or vinyl ether. The acrylate rubbers may also contain relatively small amounts, preferably up to 5% by weight (based on the weight of rubber) of copolymerized ethylenically unsaturated monomers having crosslinking action. Examples of crosslinking agents are alkylenediol diacrylates and alkylenediol methacrylates, polyester diacrylates and polyester methacrylates, divinylbenzene, trivinylbenzene, triallyl cyanurate, allyl acrylate, allyl methacrylate, butadiene or isoprene. Graft bases may also be acrylate rubbers with core/shell structure, with a core composed of crosslinked diene rubber composed of one or more conjugated dienes, such as polybutadiene, or of a copolymer of a conjugated diene with an ethylenically unsaturated monomer, such as styrene and/or acrylonitrile.

Examples of other suitable rubbers are those known as EPDM rubbers (polymers composed of ethylene and of propylene and of a non-conjugated diene, e.g. dicyclopentadiene), EPM rubbers (ethylene-propylene rubbers) and silicone rubbers, which likewise may, if appropriate, have a core/shell structure.

Preferred rubbers B.2) for preparation of the graft polymers B) are diene rubbers and alkyl acrylate rubbers, and also EPDM rubbers.

The rubbers B.2) take the form of at least to some extent crosslinked particles whose median particle diameter (d₅₀) is from 0.05 to 20 μm, preferably from 0.1 to 2 μm, and particularly preferably from 0.1 to 0.8 μm.

The median particle diameter d₅₀ is determined via ultracentrifuge measurements, according to W. Scholtan et al., Kolloid-Z. u. Z. Polymere 250 (1972), 782-796, or via evaluation of electron micrographs.

The polymers B) may be prepared via free-radical graft polymerization of the monomers B.1) in the presence of the rubbers B.2) intended as graft substrate.

Preferred preparation processes for the graft polymers B) are emulsions, solutions, bulk or suspension polymerization and combinations known per se composed of these processes. ABS polymers are particularly preferred graft polymers B).

Very particularly preferred graft polymers B) are products obtained via free-radical polymerization of mixtures composed of styrene and acrylonitrile, preferably in the ratio by weight of from 10:1 to 1:1, particularly preferably in a ratio by weight of from 5:1 to 2:1, in the presence of a rubber which has a median particle diameter (d₅₀) of from 100 to 450 nm, and which is mainly composed of diene monomers, preferably polybutadiene, which may comprise up to 30% by weight of styrene and/or acrylonitrile as comonomers, and very particularly preferably in the presence of two rubbers B.2.a) and B.2.b) with a median particle diameter (d₅₀) of from 150 to 300 nm and, respectively, with a median particle diameter (d₅₀) of from 350 to 450 nm and which are mainly composed of diene monomers, preferably in each case polybutadiene which may comprise up to 30% by weight of styrene and/or acrylonitrile as comonomers, the ratio by weight B.2.a):B.2.b) being from 10:90 to 90:10, preferably from 30:70 to 60:40.

The rubber content of the graft polymers B) is preferably from 40 to 95% by weight, particularly preferably from 50 to 90% by weight, and very particularly preferably from 55 to 85% by weight.

According to the invention, suitable partially oxidized polyolefins C) are, by way of example, partially oxidized polyethylene and partially oxidized polypropylene, or partially oxidized polyethylene wax and partially oxidized polypropylene wax. Compounds of this type are known and are, by way of example, described by A. Thalhofer in Kunststoff-Handbuch [Plastics Handbook], Volume IV (Polyolefins), pp. 161-165 (Carl Hanser Verlag, Munich 1969). The name given to compounds of this type when available commercially is often polar polyolefin waxes or polar polyethylene wax, or polar polypropylene wax.

The component D) used comprises magnesium oxide or calcium oxide, or a mixture of these.

The inventive ABS compositions may in principle comprise, in addition to the inventive additive mixtures C)+D), other additive components which improve processability.

Examples of compounds of this type are long-chain carboxamide compounds, such as ethylenediaminebisstearylamide, erucamide, oleamide, stearamide, succinamide, montanamide, long-chain carboxylic ester compounds, such as glycerol tristearate, glycerol trioleate, glycerol tribehenate, glycerol trimontanate, stearyl stearate, stearyl oleate, stearyl behenate, stearyl montanate, oleyl stearate, oleyl oleate, oleyl behenate, oleyl montanate, behenyl stearate, behenyl oleate, behenyl behenate, behenyl montanate, octyl stearate, isooctyl stearate, dodecyl stearate, dodecyl oleate, glycerol monostearate, glycerol distearate, glycerol monooleate, glycerol dioleate, pentaerythritol tetrastearate, pentaerythritol tetraoleate, pentaerythritol tetrabehenate, pentaerythritol tetramontanate, pentaerythritol tristearate, pentaerythritol trioleate, pentaerythritol tribehenate, pentaerythritol trimontanate, pentaerythritol monostearate, pentaerythritol monoolate, pentaerythritol monobehenate, pentaerythritol monomontanate, long-chain carboxylic salt compounds, such as magnesium stearate, calcium stearate, zinc stearate, magnesium montanate, calcium montanate, zinc montanate, magnesium behenate, calcium behenate, zinc behenate, magnesium oleate, calcium oleate, zinc oleate.

The inventive molding compositions preferably comprise none of the long-chain carboxylic acid derivatives mentioned.

Very particularly preferred inventive molding compositions are composed of
A) from 85 to 35% by weight of thermoplastic copolymer composed of from 5 to 40 parts by weight of acrylonitrile and from 95 to 60 parts by weight of styrene, α-methylstyrene, acrylonitrile, N-phenylmaleimide, or a mixture of these,
B) from 15 to 65% by weight of graft polymer of from 25 to 60 parts by weight of styrene, α-methylstyrene, acrylonitrile, N-phenylmaleimide, or a mixture of these onto from 75 to 40 parts by weight of polybutadiene which may contain up to 30% by weight of styrene and/or acrylonitrile as comonomers, and from 0.2 to 1.5 parts by weight (per 100 parts by weight of A+B) of a combination composed of
C) oxidized polyethylene wax and
D) magnesium oxide.

The inventive molding compositions, comprising A), B), C) and D) and, if appropriate, conventional additives, such as processing aids, stabilizers, pigments, antistatic agents, fillers, are prepared by simultaneously or successively mixing the respective constituents in a known manner at room temperature or at a higher temperature and then subjecting them to melt-compounding or melt-extrusion at temperatures of from 150° C. to 300° C. in conventional assemblies, such as internal mixers, extruders or twin-screw systems.

The molding compositions of the present invention may be used for production of moldings of any type, and conventional methods of production can be utilized here, extrusion being a particular method that can be used to produce moldings.

In principle it is also possible to process the inventive molding compositions via injection molding.

The present invention therefore also provides a process for preparation of the molding compositions, their use for production of moldings, and also the resultant moldings. The present invention further provides the additive combination composed of C) and D) itself.

The invention is illustrated by the following examples.

### EXAMPLES

Thermoplastic Resin A

Random styrene-acrylonitrile copolymer (ratio by weight 72:28) with M_{w} of about 115 000, determined via GPC (gel permeation chromatography).

Graft Polymer B-I

Grafted product obtained via emulsion polymerization of 42% by weight of a styrene/acrylonitrile mixture (ratio by weight 73:27) onto 58% by weight of a 1:1 mixture (ratio by weight) of two particulate polybutadienes with a) a median particle diameter (d₅₀) of 290 nm and b) a median particle diameter (d₅₀) of 420 nm, work-up via coagulation of the latex with a magnesium sulphate/acetic acid mixture, washing with water and then drying in vacuo.

Graft polymer B-II

Grafted product obtained via emulsion polymerization of 50% by weight of a styrene/acrylonitrile mixture (ratio by weight 73:27) onto 50% by weight of particulate polybutadiene with a median particle diameter (d₅₀) of 130 nm, and work-up as in B-I.

Additive C:

Oxidized polyethylene: Licowax PED 191 (Clariant GmbH, Sulzbach, Germany)

Additive D:

Magnesium oxide

The individual components were compounded in an extruder in the proportions by weight stated in table 1 together with 0.17 part by weight of a phenolic antioxidant (Irganox® 1076, Ciba), 0.30 part by weight of a sulphur-containing synergist (Irganox® PS 802, Ciba) and 0.15 part by weight of a silicone oil.

The resultant material was then extruded in a Breyer BR 60 extruder with a 6-zone vented screw, screw diameter 60 mm, length 33D, melt pump, choke-bar/adjustable-lip die, width 350 mm, die 3 mm, 3-roll calender and vertical roll arrangement, to give sheets. The extruder temperature was 240° C., the die temperature was 240° C. and the take-off speed was 1.5 m/min, and the total extrusion time was in each case 8 h.

The point at which disruption of the surface of the extrudates began to form about 0.5-20 mm round or elongate defects was observed. As can be seen from table 1, long periods of extrusion processing without disruption of the surface of the extruded part are achieved only when using the inventive ABS compositions.

TABLE 1
Formulations and properties

| | A | B-I | B-II | C | D | Appearance of |
|---|---|---|---|---|---|---|
| | (parts | (parts | (parts | (parts | (parts | surface |
| | by | by | by | by | by | disruption |
| Example | wt.) | wt.) | wt.) | wt.) | wt.) | after x hours |
| 1 | 55 | 27 | 18 | 0.5 | 0.3 | no disruption |
| | | | | | | of surface |
| 2 | 55 | 27 | 18 | — | — | 0.5 h |
| (comparison) | | | | | | |
| 3 | 55 | 27 | 18 | 0.5 | — | 2 h |
| (comparison) | | | | | | |
| 4 | 55 | 27 | 18 | — | 0.3 | 1 h |
| (comparison) | | | | | | |
| 5 | 65 | 21 | 14 | 0.5 | 0.3 | no disruption |
| | | | | | | of surface |
| 6 | 65 | 21 | 14 | — | — | 1 h |
| (comparison) | | | | | | |
| 7 | 65 | 21 | 14 | 0.5 | — | 2 h |
| (comparison) | | | | | | |
| 8 | 65 | 21 | 14 | — | 0.3 | 1.5 h |
| (comparison) | | | | | | |

It will be understood that the specification and examples are illustrative but not limitative of the present invention and that other embodiments within the spirit and scope of the invention will suggest themselves to those skilled in the art.

What is claimed is:

1. A molding composition, comprising:
A) from 5 to 95% by weight (based on A+B) of at least one thermoplastic homo-, co- or terpolymer of styrene, of α-methylstyrene, of ring-substituted styrene, of methyl methacrylate, of acrylonitrile, of methacrylonitrile, of maleic anhydride, of N-substituted maleimide, or of a mixture of these,
B) from 95 to 5% by weight (based on A+B) of at least one graft polymer of
B.1) from 5 to 90 parts by weight of styrene, of α-methylstyrene, of ring-substituted styrene, of methyl methacrylate, of acrylonitrile, of methacrylonitrile, of maleic anhydride, of N-substituted maleimide, or of a mixture of these, onto
B.2) from 95 to 10 parts by weight of at least one rubber with a glass transition temperature ≦10° C. in the form of at least to some extent crosslinked particles with a median particle diameter (d₅₀) of from 0.05 to 20 μm,
and also
C) from 0.05 to 5 parts by weight (per 100 parts by weight of A+B) of at least one partially oxidized polyolefin and
D) from 0.05 to 2 parts by weight (per 100 parts by weight of A+B) of at least one alkaline earth metal oxide selected from magnesium oxide and calcium oxide.

2. The molding composition, comprising:
A) from 10 to 90% by weight (based on A+B) of at least one thermoplastic homo-, co- or terpolymer of styrene, of α-methylstyrene, of ring-substituted styrene, of methyl methacrylate, of acrylonitrile, of methacrylonitrile, of maleic anhydride, of N-substituted maleimide, or of a mixture of these,
B) from 90 to 10% by weight (based on A+B) of at least one graft polymer of
B.1) from 20 to 80 parts by weight of styrene, of α-methylstyrene, of ring-substituted styrene, of methyl methacrylate, of acrylonitrile, of methacrylonitrile, of maleic anhydride, of N-substituted maleimide, or of a mixture of these, onto
B.2) from 80 to 20 parts by weight of at least one rubber with a glass transition temperature ≦10° C.,
C) from 0.1 to 3 parts by weight (in each case per 100 parts by weight of A+B) of at least one partially oxidized polyolefin and
D) from 0.08 to 1.5 parts by weight (in each case per 100 parts by weight of A+B) of at least one alkaline earth metal oxide selected from magnesium oxide and calcium oxide.

3. The molding composition according to claim 1, wherein A) is a copolymer composed of styrene and acrylonitrile.

4. The molding composition according to claim 1, wherein B1) is a mixture composed of styrene and acrylonitrile.

5. The molding composition according claim 1, wherein B2) is a rubber with a median particle diameter (d₅₀) of from 100 to 450 nm, composed of polybutadiene, which may contain up to 30% by weight of styrene and/or acrylonitrile as comonomers.

6. The molding composition according claim 1, wherein B2) comprises two rubbers B.2.a) and B.2.b) with a median particle diameter (d₅₀) of from 150 to 300 nm and, respectively, with a median particle diameter (d₅₀) of from 350 to 450 nm, in a ratio B.2.a):B.2.b) by weight of from 10:90 to 90:10, each composed of polybutadiene which may contain up to 30% by weight of styrene and/or acrylonitrile as comonomers.

7. The molding composition according claim 1, wherein D) is magnesium oxide.

8. A method of use of a molding composition according to claim 1 for production of sheets via extrusion.

9. A method of use of a molding composition according to claim 2 for production of sheets via extrusion.

10. The molding obtained via extrusion from the molding compositions according to claim 1.

11. The molding obtained via extrusion from the molding compositions according to claim 2.

12. A formulation comprising from 0.05 to 5 parts by weight of at least one partially oxidized polyolefin C) and from 0.05 to 2 parts by weight of at least one alkaline earth metal oxide D) selected from magnesium oxide and calcium oxide.
